(19) United States
(12) Patent Application Publication
(10) Pub. No.: US 2014/0327249 A1
(43) Pub. Date: Nov. 6, 2014

(54) Internal Locking Mechanism for an Externally Locked Door

(71) Applicant: Joseph Snyder, Highland, NY (US)

(72) Inventor: Joseph Snyder, Highland, NY (US)

(21) Appl. No.: 14/268,354

(22) Filed: May 2, 2014

Related U.S. Application Data
(60) Provisional application No. 61/818,584, filed on May 2, 2013.

(51) Int. Cl. E05C 1/00

(52) U.S. Cl. CPC E05C 1/006
USPC 292/163

(57) ABSTRACT

An apparatus with a fixed plate and a lock blocking bracket is used to lock doors that can only be locked from outside. The fixed plate has a knob guide opening, a recessed track, and an arm guide opening. The lock blocking bracket has an inner plate, an offset arm, an outer plate, and a control knob. The inner plate and the outer plate are perpendicular to each other and are connected by the offset arm, which allow the lock blocking bracket to brace the corner of a door frame. The outer plate is placed in the recessed track so that the outer plate can slide up and down within the recessed track. The control knob is placed within the knob guide opening. Furthermore, the offset arm is placed within the arm guide opening. The range of motion of the lock blocking bracket is controlled by the control knob.

The current application claims a priority to the U.S. Provisional Patent application Ser. No. 61/818,584 filed on May 2, 2013.

### FIELD OF THE INVENTION

The present invention relates generally to the field of door locking equipment. More specifically, the present invention is an additional apparatus utilized with doors that can only be locked from the outside.

### BACKGROUND OF THE INVENTION

As witnessed in the recent past, an alarming increase in crime rate is seen in schools, offices, banks and other locations with a large number of people. Unfortunately, if proper safety precautions were put into action the extent of the damage could have been greatly reduced. For instance, the number of victims of the numerous school shootings could have been reduced if the children were locked inside the respective classrooms. Unfortunately, the existing safety features left the occupants exposed. The main reason the children were exposed is because most classroom doors lacked the ability to be locked from inside. The doors needed to be opened and locked from outside. Opening a door during emergency situations can be extremely dangerous if an intruder is in the vicinity. The issue of not having doors that can be locked from inside has been recognized during the numerous lock down drills conducted in the recent past. Nevertheless, an effective solution has not been introduced. Door chain locks seen in many residential areas address the issue to some extent. However, door chain locks do not guarantee complete security.

The objective of the present invention is to address the aforementioned issue. In particular, the present invention is an apparatus that is attached to the door frame allowing a user to have control of the door lock. When utilizing the present invention the door lock is always in its locked position. However, the present invention prevents the door lock from engaging into the door frame. When the need occurs to lock a door, a user can conveniently lock the door with a slide of a component. Therefore, the present invention introduces a convenient and effective way of locking a door that guarantees security.

### BRIEF DESCRIPTION OF THE DRAWINGS

FIG. 1 is a perspective view of the present invention.

FIG. 2 is a side view of the present invention.

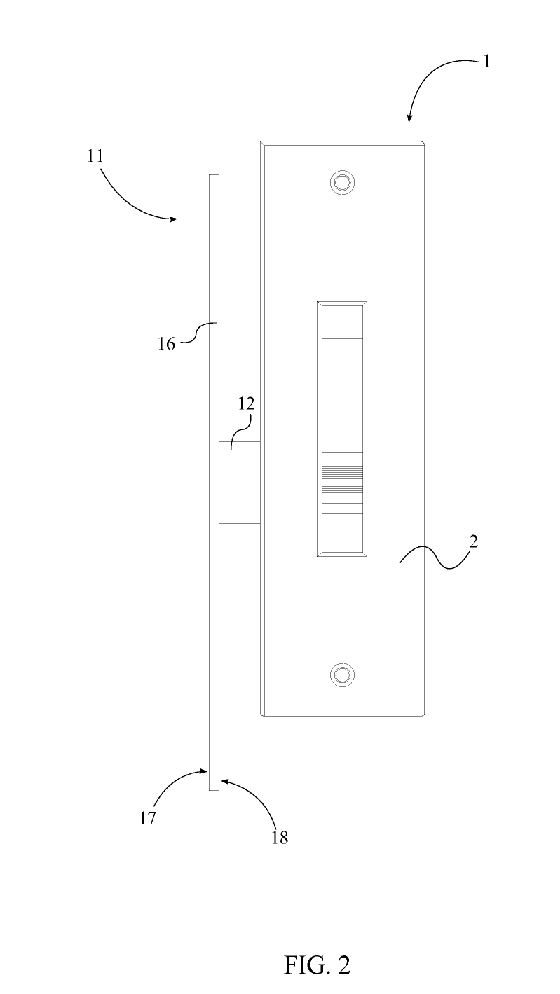

FIG. 3 is a perspective view of the fixed plate of the present invention.

FIG. 4 is a back view of the fixed plate of the present invention.

FIG. 5 is a perspective view of the lock blocking bracket of the present invention.

FIG. 6 is a perspective view of the present invention being used on a door lock.

FIG. 7 is a side view of the present invention being used on a door lock.

FIG. 8 is a side view of the present invention with the door in its locked position.

### DETAIL DESCRIPTIONS OF THE INVENTION

All illustrations of the drawings are for the purpose of describing selected versions of the present invention and are not intended to limit the scope of the present invention.

A majority of the doors seen in schools and offices cannot be locked from inside. In order to lock the door, these doors should be opened or the door needs to be locked from outside. The present invention is an apparatus that can be used on such doors that cannot be locked from inside. The present invention allows a user to lock such doors without opening the door. With the increase in crimes, the present invention can be especially beneficial in locations such as schools, offices etc. For instance, if an intruder is in the vicinity, the door can be locked from within the classroom or office.

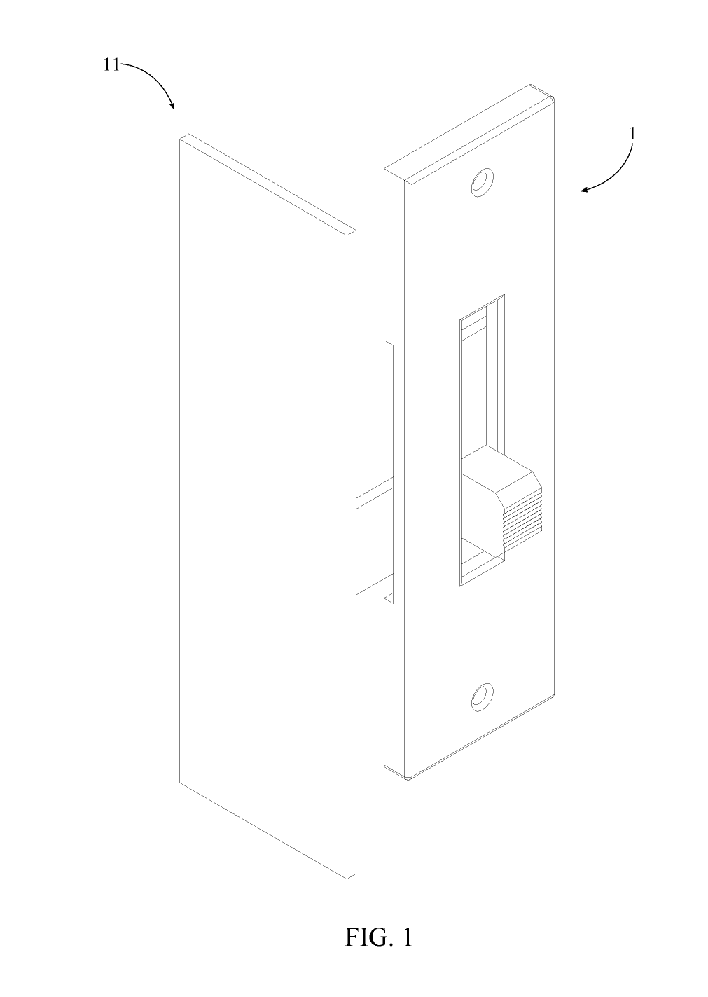

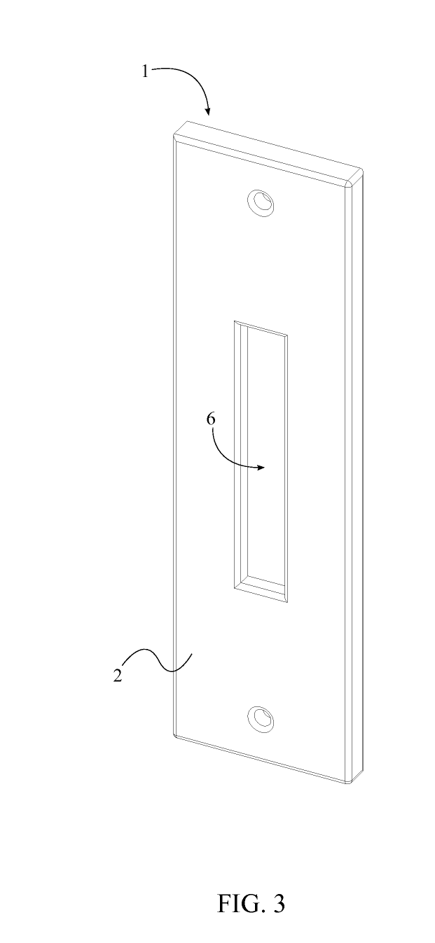

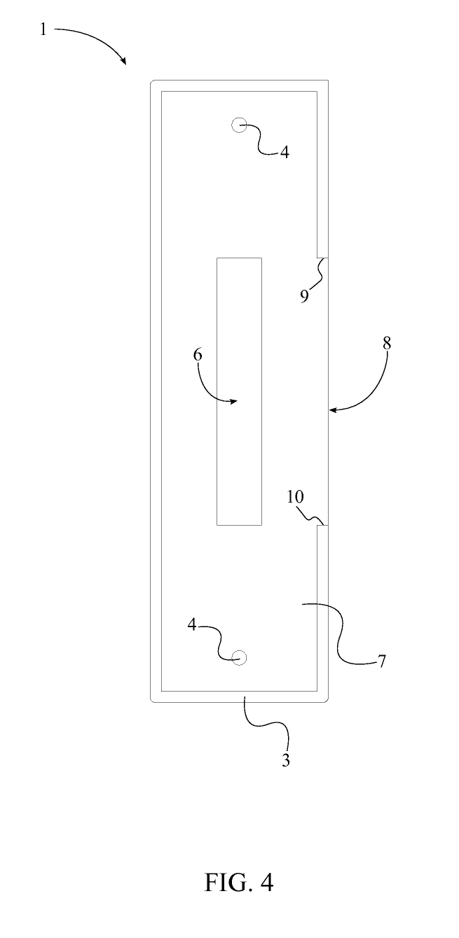

As seen in FIG. 1, the present invention comprises a fixed plate 1 and a lock blocking bracket 11. In the preferred embodiment of the present invention, the fixed plate 1 and the lock blocking bracket 11 are both made of plastic. However, any other comparable material for the fixed plate 1 and the lock blocking bracket 11 is also satisfactory. As illustrated in FIG. 3 and FIG. 4, the fixed plate 1 comprises an exposed surface 2, a wall surface 3, a knob guide opening 6, a recessed track 7, and an arm guide opening 8. As seen in FIG. 3, the exposed surface 2 is rectangular in shape. When the present invention is installed on a door frame, the exposed surface 2 is parallel to the door frame. The wall surface 3 lies flush against the door frame. The recessed track 7 traverses into the fixed plate 1 from the wall surface 3 creating an empty space between the exposed surface 2 and the door frame. The knob guide opening 6 traverses through the fixed plate 1 from the exposed surface 2 to the wall surface 3. In the preferred embodiment of the present invention, the knob guide opening 6 is rectangular in shape. The length of the knob guide opening 6 can vary according to the range required for the lock blocking bracket 11. As seen in FIG. 4, the arm guide opening 8 traverses into the recessed track 7. Furthermore, the arm guide opening 8 traverses into the recessed track 7, perpendicular to the knob guide opening 6. The arm guide opening 8 determines the range that the lock blocking bracket 11 can move in.

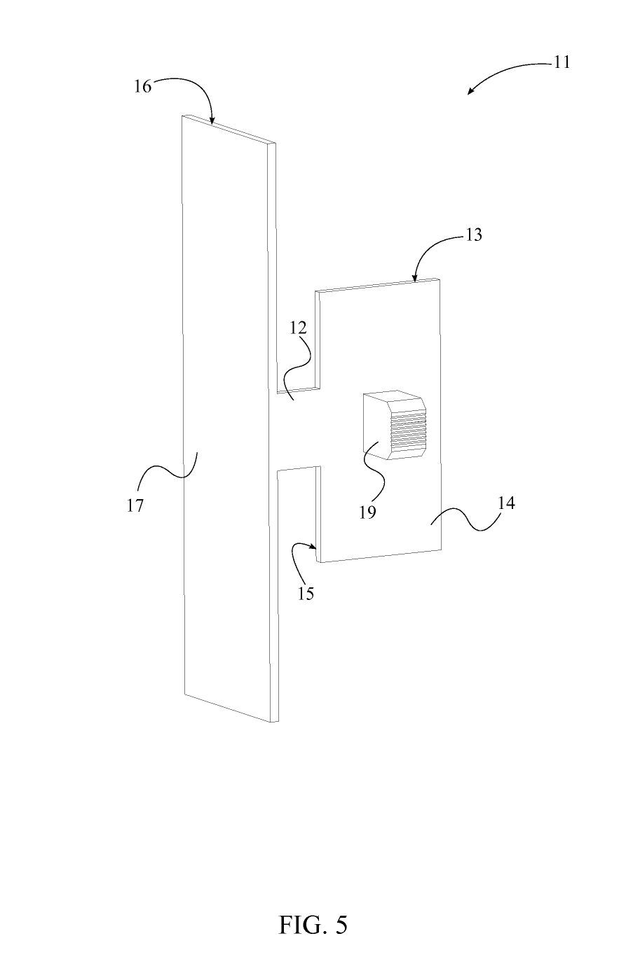

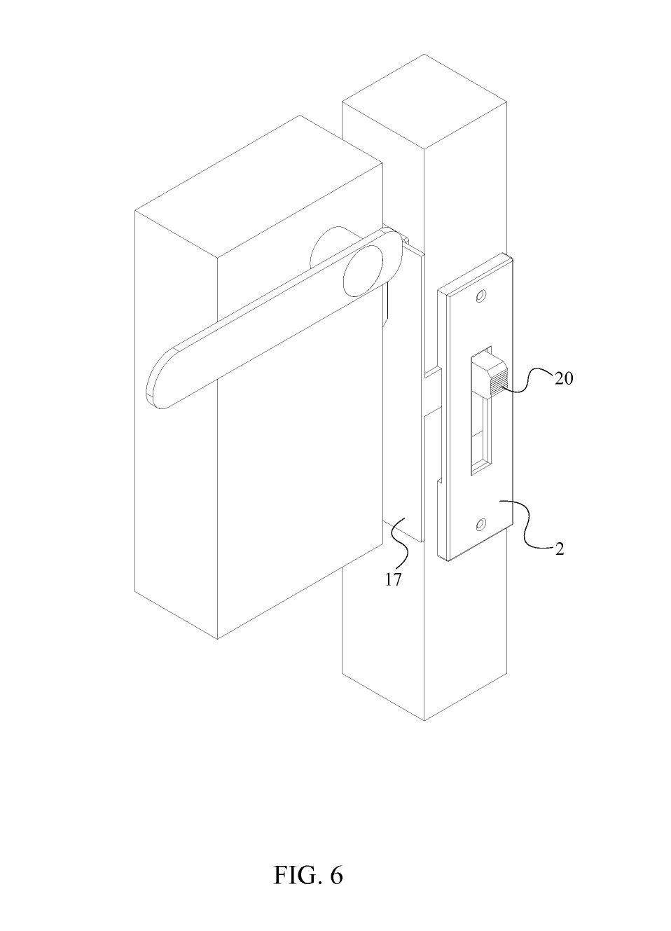

As illustrated in FIG. 5, the lock blocking plate 11 comprises an inner plate 16, an offset arm 12, an outer plate 13, and a control knob 19. Both the inner plate 16 and the outer plate 13 are rectangular in shape. However, any other comparable shape for the inner plate and the outer plate is also satisfactory. The outer plate 13 is positioned perpendicular to the inner plate 16. The offset arm 12 connects the outer plate 13 and the inner plate 16. The right angle between the outer plate 13 and the inner plate 16 allows the present invention to be installed on the edge of a door frame as illustrated in FIGS. 6-8. The outer plate 13 comprises a front surface 14 and a rear surface 15. The control knob 19 is connected normal to the front surface 14 and is used to control the position of the inner plate 16. The outer plate 13 is slidably engaged within the recessed track 7 of the fixed plate 1. The positioning of the outer plate 13 places the offset arm 12 within the arm guide opening 8. Simultaneously, the control knob 19 is also positioned in the knob guide opening 6.

As seen in FIG. 3 and FIG. 4, the fixed plate 1 comprises a plurality of fastener receiving holes 4. The plurality of fastener receiving holes 4 traverses through the fixed plate 1 from the exposed surface 2 to the wall surface 3. In the preferred embodiment of the present invention, the plurality of fastener receiving holes 4 is positioned around the knob guide opening 6. However, any other comparable position for the plurality of fastener holes 4 is also acceptable. A plurality of fasteners 5 is engaged with the plurality of fastener receiving holes 4 to secure the present invention against a door frame. The present invention is secured in close proximity to the locking bolt engagement point on the door frame. Even though a plurality of fasteners 5 is utilized to secure the present invention against the door frame, an adhesive or other comparable means can also be utilized.

As seen in FIG. 4, the arm guide opening 8 traverses into the recessed track 7. The arm guide opening 8 comprises a first stopping edge 9 and a second stopping edge 10. The offset arm 12 is slidably engaged to the arm guide opening 8 between the first stopping edge 9 and the second stopping edge 10. Since the offset arm 12 is connected to the inner plate 16, the inner plate 16 also has a similar range of motion. As an example, if the offset arm 12 is in contact with the first stopping edge 9, the door is unlocked, and if the offset arm 12 is in contact with the second stopping edge 10, the door is locked.

As illustrated in FIG. 6, the outer plate 13 is laterally pressed against the recessed track 7. Furthermore, the front surface 14 is also pressed against the recessed track 7. The space available between the wall surface 3 and the exposed surface 2 allows the outer plate 13 to move vertically. Using the control knob 19, the position of the outer plate 13 can be controlled. The outer plate 13 is connected to the inner plate 16 with the offset arm 12. Hence, the position of the inner plate 16 can also be controlled with the control knob 19.

The control knob 19 is centrally positioned on the outer plate 13. The positioning of the control knob 19 allows convenient control of the lock blocking bracket 11. The control knob 19 comprises a plurality of grooves 20. The plurality of grooves 20 is positioned onto the control knob 19, opposite the outer plate 13. The plurality of grooves 20 gives the user more control over the lock blocking bracket 11.

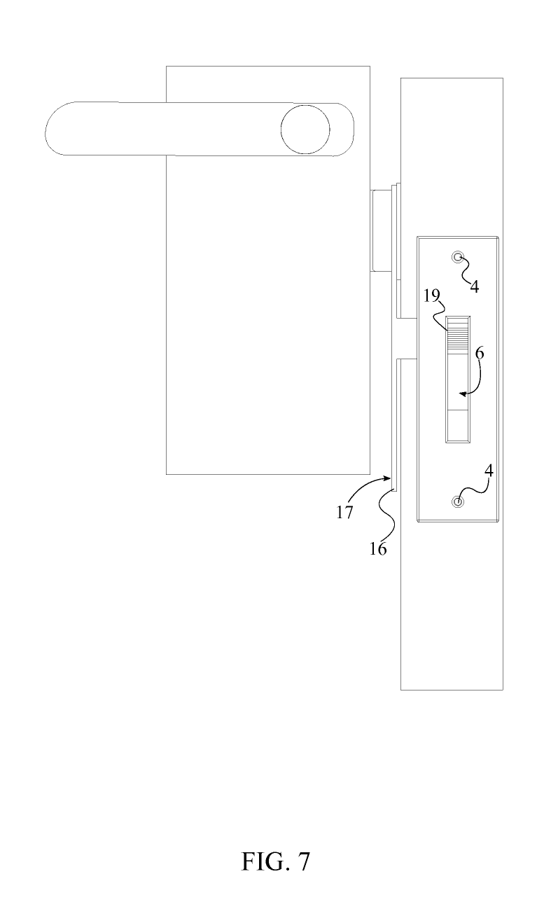

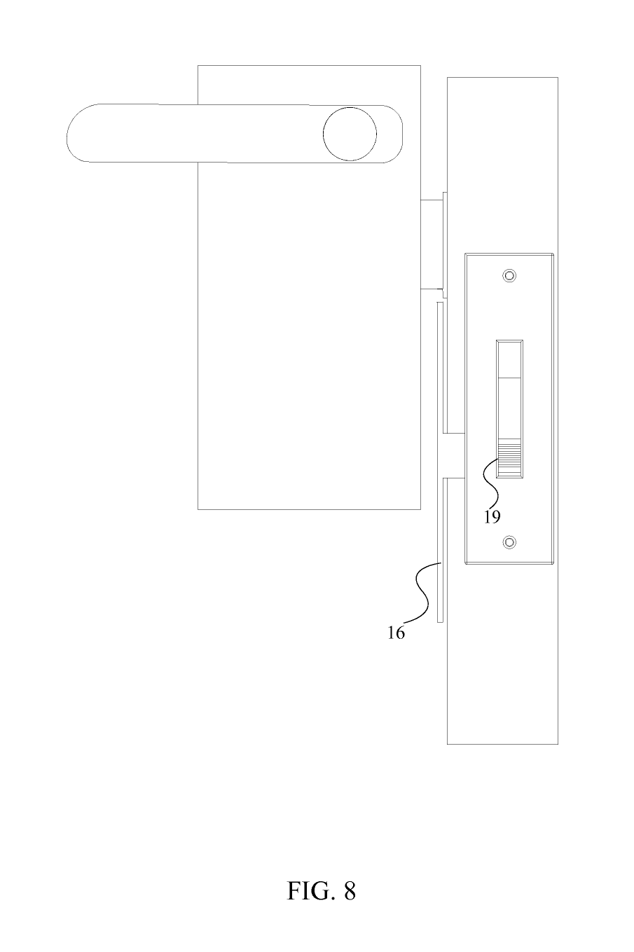

The inner plate 16 of the lock blocking bracket 11 comprises a left surface 17 and a right surface 18. When the present invention is installed on a door frame as illustrated in FIGS. 6-8, the left surface 17 is in contact with the locking bolt of the door lock. The right surface 18 is in contact with the door frame. As seen in FIG. 7, the positioning of the inner plate 16 restricts the door bolt from engaging with the door frame. Furthermore, the position of the inner plate 16 as seen in FIG. 8 allows the locking bolt to engage in the door frame.

When utilizing the present invention on a door, the door is always in locked position. However, as seen in FIG. 7, the inner plate 16 restricts locking bolt from engaging with the door frame. In case of an emergency or locking need, a user slides the control knob 19 downwards or upwards. The direction of the slide depends on the positioning of the present invention on the door frame. If the control knob 19 was slid downwards, the resulting position of the inner plate 16 is illustrated in FIG. 8. The sliding of the control knob 19 allows the locking bolt to engage with the door frame resulting in the door being locked.

Although the invention has been explained in relation to its preferred embodiment, it is to be understood that many other possible modifications and variations can be made without departing from the spirit and scope of the invention as hereinafter claimed.

What is claimed is:

1. An internal locking mechanism for an externally locked door comprises:
a fixed plate;
a lock blocking bracket;
the fixed plate comprises an exposed surface, a wall surface, a knob guide opening, a recessed track, and an arm guide opening;
the lock blocking plate comprises an inner plate, an offset arm, an outer plate, and a control knob;
the outer plate comprises a front surface and a rear surface;
the recessed track traversing into the fixed plate from the wall surface;
the knob guide opening traversing through the fixed plate from the exposed surface to the wall surface;
the knob guide opening being centrally aligned with the recessed track;
the arm guide opening traversing into the fixed plate, perpendicular the knob guide opening;
the arm guide opening traversing into the recessed track;
the outer plate being positioned perpendicular to the inner plate;
the outer plate being connected adjacent to the inner plate by the offset arm;
the control knob being connected normal to the front surface;
the outer plate being slidably engaged to the recessed track;
the offset arm being positioned through the arm guide opening; and
the control knob being positioned through the knob guide opening.

2. The internal locking mechanism for an externally locked door as claimed in claim 1 comprises:
a plurality of fastener receiving holes;
a plurality of fasteners;
the plurality of fastener receiving holes traversing through the fixed plate from the exposed surface to the wall surface;
the plurality of fastener receiving holes being positioned around the knob guide opening; and
the plurality of fasteners being engaged to the plurality of fastener receiving holes.

3. The internal locking mechanism for an externally locked door as claimed in claim 1 comprises:
the arm guide opening comprises a first stopping edge and a second stopping edge;
the first stopping edge and the second stopping edge being positioned opposite to each other along the arm guide opening; and
the offset arm being slidably engaged to the arm guide opening between the first stopping edge and the second stopping edge.

4. The internal locking mechanism for an externally locked door as claimed in claim 1 comprises:
the outer plate being laterally pressed against the recessed track; and
the front surface of the outer plate being pressed against the recessed track.

5. The internal locking mechanism for an externally locked door as claimed in claim 1 comprises:
the control knob being centrally positioned on the outer plate;
the control knob comprises a plurality of grooves; and
the plurality of grooves being positioned onto the control knob, opposite the outer plate.

6. An internal locking mechanism for an externally locked door comprises:
a fixed plate;
a lock blocking bracket;
a plurality of fastener receiving holes;
a plurality of fasteners;
the fixed plate comprises an exposed surface, a wall surface, a knob guide opening, a recessed track, and an arm guide opening;
the lock blocking plate comprises an inner plate, an offset arm, an outer plate, and a control knob;
the outer plate comprises a front surface and a rear surface;
the recessed track traversing into the fixed plate from the wall surface;
the knob guide opening traversing through the fixed plate from the exposed surface to the wall surface;
the knob guide opening being centrally aligned with the recessed track;
the arm guide opening traversing into the fixed plate, perpendicular the knob guide opening;
the arm guide opening traversing into the recessed track;
the outer plate being positioned perpendicular to the inner plate;
the outer plate being connected adjacent to the inner plate by the offset arm;
the control knob being connected normal to the front surface;
the outer plate being slidably engaged to the recessed track;
the offset arm being positioned through the arm guide opening;
the control knob being positioned through the knob guide opening;
the plurality of fastener receiving holes traversing through the fixed plate from the exposed surface to the wall surface;
the plurality of fastener receiving holes being positioned around the knob guide opening; and
the plurality of fasteners being engaged to the plurality of fastener receiving holes.

7. The internal locking mechanism for an externally locked door as claimed in claim 6 comprises:
the arm guide opening comprises a first stopping edge and a second stopping edge;
the first stopping edge and the second stopping edge being positioned opposite to each other along the arm guide opening;
the offset arm being slidably engaged to the arm guide opening between the first stopping edge and the second stopping edge;
the outer plate being laterally pressed against the recessed track; and
the front surface of the outer plate being pressed against the recessed track.

8. The internal locking mechanism for an externally locked door as claimed in claim 6 comprises:
the control knob being centrally positioned on the outer plate;
the control knob comprises a plurality of grooves; and
the plurality of grooves being positioned onto the control knob, opposite the outer plate.

9. An internal locking mechanism for an externally locked door comprises:
a fixed plate;
a lock blocking bracket;
a plurality of fastener receiving holes;
a plurality of fasteners;
the fixed plate comprises an exposed surface, a wall surface, a knob guide opening, a recessed track, and an arm guide opening;
the lock blocking plate comprises an inner plate, an offset arm, an outer plate, and a control knob;
the outer plate comprises a front surface and a rear surface;
the recessed track traversing into the fixed plate from the wall surface;
the knob guide opening traversing through the fixed plate from the exposed surface to the wall surface;
the knob guide opening being centrally aligned with the recessed track;
the arm guide opening traversing into the fixed plate, perpendicular the knob guide opening;
the arm guide opening traversing into the recessed track;
the outer plate being positioned perpendicular to the inner plate;
the outer plate being connected adjacent to the inner plate by the offset arm;
the control knob being connected normal to the front surface;
the outer plate being slidably engaged to the recessed track;
the offset arm being positioned through the arm guide opening;
the control knob being positioned through the knob guide opening;
the plurality of fastener receiving holes traversing through the fixed plate from the exposed surface to the wall surface;
the plurality of fastener receiving holes being positioned around the knob guide opening;
the plurality of fasteners being engaged to the plurality of fastener receiving holes;
the outer plate being laterally pressed against the recessed track; and
the front surface of the outer plate being pressed against the recessed track.

10. The internal locking mechanism for an externally locked door as claimed in claim 9 comprises:
the arm guide opening comprises a first stopping edge and a second stopping edge;
the first stopping edge and the second stopping edge being positioned opposite to each other along the arm guide opening;
the offset arm being slidably engaged to the arm guide opening between the first stopping edge and the second stopping edge;
the control knob being centrally positioned on the outer plate;
the control knob comprises a plurality of grooves; and
the plurality of grooves being positioned onto the control knob, opposite the outer plate.
